(19) United States
(12) Patent Application Publication
(10) Pub. No.: US 2014/0074555 A1
(43) Pub. Date: Mar. 13, 2014

(54) Match Scenario mechanism and display

(71) Applicant: Mercer (US) Inc, New York, NY (US)

(72) Inventors: Christopher Jan TenHoeve, Stockholm, NJ (US); Teri Zipper, Louisville, KY (US); Danielle Bushen, Oakville (CA)

(73) Assignee: Mercer (US) Inc, New York, NY (US)

(21) Appl. No.: 14/023,604

(22) Filed: Sep. 11, 2013

Related U.S. Application Data
(60) Provisional application No. 61/699,434, filed on Sep. 11, 2012.

(51) Int. Cl. G06Q 30/02

(52) U.S. Cl. CPC G06Q 30/0201
USPC 705/7.34; 705/7.29; 705/7.33

(57) ABSTRACT

A job benchmarking system and method that allow a user to create a job scenario for a job based on scenario attributes, according to the market value of the job. A job modeling engine generates the job scenario for the job based on defined scenarios having defined scenario attributes and quantified market value dimensionalities representative of the market value of the job. After generating the job scenario, a user can request a comparison with other generated scenarios for the job. When a scenario is satisfactory, it can be formatted to work with a human resources system, such as for posting a job opportunity.

This application claims priority to U.S. provisional application 61/699,434, filed Sep. 11, 2012. U.S. provisional application 61/699,434 is incorporated herein by reference in its entirety.

### FIELD OF THE INVENTION

The field of the invention is benchmark modeling of a job.

### BACKGROUND

As companies become globe-spanning or diversified organizations, they find jobs (e.g., roles, responsibilities, etc.) within the organizations become quite diversified in many respects. For example, a single job in the organization could have various attributes affected by the jurisdiction where the job will be located, educational drivers for the job, or other aspects that affect how the job is valued within the organization. Thus, it is difficult for Human Resources (hereinafter “HR”) to determine a practical market value for such evolving jobs. Ideally, an organization would benefit from creating a market value benchmark for their jobs.

Employee benchmarking has been generally discussed in U.S. Pat. Pub. No. 2010/0153289 A1 to Schneiderman et al., which discloses a method for dynamically generating a customized employment profile for a company. Additionally, U.S. Pat. Pub. No. 2001/0034011 A1 to Bouchard describes benchmarking the fitness of a candidate for a position by collecting responses to questionnaires from supervisors and top employees. Still further, U.S. Pat. No. 8,015,197 B2 to Zitaner et al. describes competitive reward benchmarking. In a more generic sense, others have modeled system using benchmarking techniques. Examples include, U.S. Pat. No. 7,249,006 B2 to Lombardo et al. with respect to bio-surveillance or U.S. Pat. No. 7,945,472 B2 to Pappas et al. with respect to business planning

In general, the above referenced art might be useful in their purpose, but appear to lack insight into how to model a job, especially with respect to market value, within a diversified organization where the job can be modeled according to many different parameter sets. Thus, there is still a need for systems and methods for creating multiple job benchmarking scenarios.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

The inventive subject matter provides system, methods, or apparatus in which a user can benchmark jobs relative to one or more market values. One aspect of the inventive subject matter includes methods of benchmarking a job. Contemplated systems and methods include a job modeling engine capable of modeling a job within one or more organizations according to a defined scenario. These defined scenarios can represent aspects or properties of a market value for the job.

The method can include allowing a user, assuming proper authentication or authorization, to provide scenario attributes to the job modeling engine, used by the job modeling engine to construct user-defined scenarios relevant to the job according to the market value of the job (represented by the defined scenario). The user-defined scenarios can cover broad spectrum of models representing different aspects in the market, target organization, the job itself, or other factors.

In an embodiment, the user-defined scenarios can be generated based on the provided scenario attributes by executing a job analysis workflow for the plurality of user defined scenario attributes, executed with respect to the market value of the job.

The market value of a job can include a plurality of quantified market value dimensionalities. These dimensionalities are used to shape the user-defined scenario, and can include modifications and/or additions to the user-defined scenario attributes and the associated scenario attribute values used in the generation of the user-defined scenario.

In an embodiment, the user can provide less than all of the scenario attributes that apply to a particular job. During the generation of the user-designed scenario, the job modeling engine can add additional scenario attributes to the user-provided scenario attributes and generate the user-defined scenario based on the user-defined scenario attributes and the additional scenario attributes. The additional scenario attributes can include additional scenario attribute values.

In an embodiment, the job modeling engine can change the scenario attribute values for one or more scenario attributes to bring the values in line with the market value. The scenario attribute values being modified can be for the user-defined scenario attributes. In embodiments including additional scenario attributes added by the job modeling engine, the modified values can be from one or more of the user-defined scenario attributes, the additional scenario attributes, or both. The modifications can be made by selecting one or more user-defined scenario attributes as primary attributes, used as the basis of the modification. The primary attributes can reflect the user-defined attributes that are most important or critical to the user requesting the job scenario.

In a further embodiment, the modifications to one or more of the attribute values can be calculated, but the user-defined scenario generated on pre-modification attribute values. The differences can be presented along with the user-defined scenario to illustrate the deviation.

In an embodiment, the user-defined scenario can be generated to ascertain a job associated with user-defined attributes. In this case, the user-defined scenario can be generated for a plurality of market values associated with a plurality of possible jobs. The resulting user-defined scenarios can be matched with the possible jobs to find a best fit.

The job modeling engine can further configure an output device to present the job according one or more user-defined scenarios, which allows the user to compare and contrast the job with respect to the constructed scenarios, as well as against existing scenarios for the job.

The job modeling engine to activate one or more of the user-defined scenarios as a candidate description for the job. For example, a selected user-defined scenario can be submitted to an HR system as the go-forward description for the job in preparation for filling the job.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an illustration of an example execution of a method according to the inventive subject matter.

FIG. 2 is an overview of job analysis workflows according to the inventive subject matter.

FIG. 3 is an illustration of an embodiment of a user-facing interface enabling the construction of a user-defined scenario comparison for a job.

FIG. 4 is an illustration of an embodiment of an output device presenting the job with the compared match scenarios, according to the user-defined scenarios.

FIG. 5 is an embodiment demonstrating a query generation of a query to a job benchmark database.

FIG. 6 is an illustrative embodiment of a blank match screen for a job.

FIG. 7 is an illustration of an embodiment demonstrating populated matches for a job.

### DETAILED DESCRIPTION

Throughout the following discussion, numerous references will be made regarding engines, modules, servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should appreciate that the that the disclosed techniques provided for generating a signal representative of a job where the signal can be used to configure an HR system to activate the job within an organization.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document the terms “coupled to” and “coupled with” are used euphemistically to mean “communicatively coupled with” over a network, where two networked entities are capable of communicating with each over the network, possibly via one or more intermediary devices.

Benchmarking jobs can be difficult for an HR department in a global-spanning or diversified organization. Due to a number of parameters which can affect the benchmarking of a job, the systems and methods described herein enable the creation of a variety of benchmark scenarios for a job where one or more scenarios can be activated as an actual job within the organization. The disclosed techniques can be offered, for example, via a for-fee service to clients who wish to model jobs.

Generally, the inventors have appreciated that a job can be benchmarked according to different market driver scenarios. The method of benchmarking begins with access to a job modeling engine which is configured to model a job by creating scenarios as a function of at least one defined scenario, based on information about the job for which the user desires a scenario to be generated. Providing access to the job modeling engine can include offering a for-fee service via browser interface, as a Software-as-a-Service, via one or more APIs, through a third party application, as a standalone application, or other embodiment.

One should appreciate that a “job” as used herein represents a distinct manageable object regardless if the job is filled or unfilled. Thus, the reader should appreciate that a job can be distinct from an employee that fills the job. A job can correspond to a position within the organization, or correspond to other forms of roles or responsibilities. In an organization, all employees are bound to one or more jobs. However, it is entirely possible that a job lacks an employee. Therefore, the disclosed techniques seek to a benchmark job, which is considered distinct from benchmarking an employee that might fill the job. For example, benchmarking a job can include valuing roles or responsibilities associated with the job according to one or more market value drivers. For further clarity consider one or more jobs associated with a VP of Engineering as an example. The organization might wish to determine where in the world would be best to locate the jobs. The organization can define multiple scenarios for the jobs according jurisdictional attributes (e.g., USA, India, China, Vietnam, Russia, etc.), or other market drivers (e.g., costs, salary, relocation packages, good-will, morale, etc.). Through such benchmarking via multiple scenarios, the organization can best determine how, where, or when to roll out the jobs.

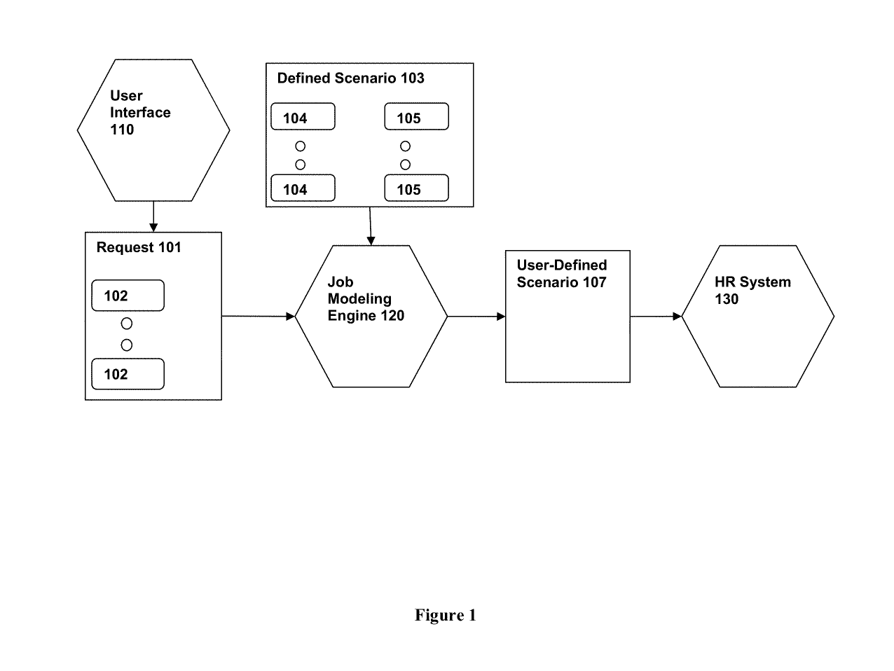

FIG. 1 illustrates an exemplary system and execution of a method of generating a user-defined scenario, according to an embodiment of the inventive subject matter.

The system can include a job modeling engine 120 responsible for the generation of user-defined scenarios as described in further detail below. In embodiments, the job modeling engine 120 can be embodied as computer-readable instructions stored on at least one non-transitory computer-readable medium, executed by one or more hardware processors to execute functions to carry out various methods and processes of the inventive subject matter. In embodiments, the job modeling engine 120 can be a computing device comprising one or more hardware processors specially programmed to carry out the various methods and processes of the inventive subject matter.

The system can include one or more databases to store the application data used by the job modeling engine 120 and other components of the system to perform the functions and processes associated with the methods of the inventive subject matter. Examples of application data can include scenario attributes, defined scenarios corresponding to market values for different jobs (including scenario attributes and/or quantified market value dimensionalities as discussed further below), previously generated user-defined scenarios, existing jobs (stored in a job benchmark database), job metrics, etc. These and other types of application data can be stored in individual databases, in combined database, or in combinations thereof. The database can be stored in one or more non-transitory memory devices, such as in a hard drive, optical drive, flash memory, or other types of storage in one or more computing devices accessible by the job modeling engine 120. The storage can be local to the job modeling engine 120, such as integral to the same device as the job modeling engine 120, or remote from the job modeling engine 120, such as in one or more server computers, and accessible by the engine 120 via a data exchange network such as a cellular network, the internet, etc.

Assuming proper authentication or authorization, a user wishing to benchmark a job can submit a request 101 for a user-defined scenario to the job modeling engine 120. The request can include one or more user-defined scenario attributes 102, which can represent the characteristics or parameters of a job that the user wishes to benchmark. These attributes 102 can also be representative of market drivers of a job. The user request 101 can include an identification of the job desired to benchmark, used by the job modeling engine 120 to identify the correct instruction sets and data associated with modeling that particular job. The identification of the job can be one of the user-defined scenario attributes 102. Alternatively, the identification information can be data separate from scenario attributes 102, expressed as metadata, a hash value, an identifier, etc., included within the request.

Examples of scenario attributes that can be used as user-defined scenario attributes 102 can include a job title, job duration (e.g., for temporary jobs, project-specific jobs, etc.), an organization name, an organization classification (e.g., size, size categorization, type of organization, private vs. publicly traded, age of organization, local vs. multinational, subsidiary information, etc.), an organization industry sector, a job industry sector, a job location, an organization location, an organization department, a position classification, a rank, an education level, an experience level (e.g., years of experience, client list, achievements/accolades, experience with types of software or equipment, etc.), a salary, benefit, vacation time, length of work day, length of work week, professional licensing/certification, job responsibilities, job tasks, job hierarchy (e.g., place of the job in the organizational structure of the organization), associated jobs (e.g., who reports to this job), a job cost (e.g., total cost of the job on the organization including salary and non-salary costs), jurisdictional requirements, and legal requirements. One or more of the user-defined scenario attributes 102 can include a user-defined scenario value provided by the user. For example, a user-defined scenario attribute of a salary can include a value of an actual salary number (single number, range, yearly, hourly, etc.) entered by the user.

Scenario attributes can have associations or relationships with other scenario attributes that can influence each others' presence in a scenario, their importance or relevance in a generated scenario, and/or their corresponding scenario attribute values. The relationship can be direct, linear, inverse, statistical, cluster-based, weighted, etc. For example, for an organization having divisions or departments in various locations, the department attribute can have a requirement that a location attribute also be included in the scenario generation. In another example, an education level attribute can have a relationship with a salary attribute whereby, all other things being equal, as the education level attribute value increases so will the salary attribute value. In another example, for a job, with all other things being equal, the relationship between salary and vacation time attributes can have a relationship whereby an increase of the salary attribute value can result in a decrease of the vacation time attribute value (e.g., where a higher paying job may require more time spent at work and thus, less vacation time).

The user can request the scenario by interacting with the system via a user interface 110 that allows for the entry of the information necessary to construct the request. The user interface 110 can be a website accessed via a browser interface, via a software application executed by a computer communicatively connected to the other components of system, or via any other interfaces that allow the user to enter data into, and receive information from, the processing components of the system. In an example, the user uses a computer to access the user interface 110 via a web browser on the computer, where the computer can include a keyboard, mouse, touch pad, touch screen, microphone, camera, stylus or any other input devices allowing for the user to enter necessary inputs, and output devices such as a display device and audio output devices allowing for the user to receive information from the system as necessary.

The user-defined scenario attributes 102 can be selected by the user based on a global list of all scenario attributes for all of the possible jobs within the system, stored in a global scenario attribute database. Alternatively, the scenario attributes list selectable by the user can be a subset of all possible attributes organized according to general, high-level categories, such as for a particular job title or industry field.

The job modeling engine 120 can receive the request submitted by the user, and generate the job scenario based on the user-defined scenario attributes 102 (and corresponding scenario attribute values) according to one or more defined scenarios 103 representative of the market value of the job.

The market value for a job can represent a number of values. One example of what the market value can represent is a market segment value. In this example, a job addresses a market need with respect to the type of goods or services a company produces (i.e., each type of products/services can separately value a job). For example, a vice-president of software engineering has different market values at Cisco, Yahoo, Intel, or Nike because each company sells different types of products/services which affect the value of jobs a vice-president of software engineering would have. In addition, the market value can represent a jurisdictional market value. In a jurisdictional market value, a job can be valued differently depending on the country, zip code, state, or province of the job. It is further contemplated that the market value can represent a demographic value (i.e., the job can represent a status within a demographic group). Still further, the market value can represent a cultural value that might represent status of the job or impact in the local community.

The defined scenarios 103 can include scenario attributes 104 having scenario attribute values reflective of the market value of the job. The scenario attributes 104 of defined scenario 103 can include scenario attributes from the same pool of attributes in the global attribute database accessed to create the user request. The values of the scenario attributes 104 for the defined scenario 103 can be default values based on market value of the job based on measured baseline data, such as historical data for a particular job. Alternatively, the values of the scenario attributes 104 can be null values, whereby the scenario attributes 104 represent baseline or reference attributes that influence or affect the market value of a job.

In an embodiment, the user-generated scenario 107 can be generated via a matching of the user-defined scenario attributes 102 to one or more of the attributes 104 of a defined scenario 103 representing the market value for that job. The matching can be performed using one or more of direct matching, mapping, statistical analysis, cluster analysis, and weighted matching techniques.

In an embodiment, the job modeling engine 120 can generate the user-defined scenario by executing a job analysis workflow. In this embodiment, the market value can be represented by a defined scenario 103 having quantified market value dimensionalities 105. The quantified market value dimensionalities 105 can be included in the defined scenario 103 in addition to or instead of defined scenario attributes 104.

The quantified market value dimensionalities 105 can be representative of aspects of the market value of a job that can affect the generation of the user-defined scenario 107 by changing the scenario attributes ultimately used in generating the user-defined scenario 107. The quantified market value dimensionalities 105 can lead to the addition or removal of scenario attributes used in generating the user-defined scenario 107. The quantified market value dimensionalities 105 can also modify the relationships between the scenario attributes, and can also affect the values of the scenario attributes accordingly.

Examples of quantified market value dimensionalities 105 can include a non-monetary impact of the job on an organization, a need of the job for an organization (e.g., for a specific organization, for an organization of that type, size, etc.), an institutional culture of an organization, a geography, an impact of the job on a local economy or good-will, effect of jurisdictional requirements on job (e.g., laws, codes, regulations, standards, licensing requirements etc.), a stress level associated with a job, a location, a monetary value, a monetary value normalization (e.g., location-based, institution-based, industry-based, etc.), a compensation package, a career projection, a career stream, a position class, a demographic, a social status associated with job, a vendor, a reputation of a profession, educational requirements of the job, and a quality of life.

The quantified market value dimensionalities 105 can be incorporated into the generation of the user-defined scenario 107 in various ways, depending on the nature of the dimensionality. In one example, quantified market value dimensionalities 105 can be weight factors or weighted values reflecting the effect the dimensionalities (individually, grouped, or collectively) have on a job, applied to the scenario attributes to affect their values. In another example, the dimensionalities can include rules regarding the relationship of one or more scenario attributes, including creating new associations between scenario attributes that previously did not have them, modifying existing associations between scenario attributes or removing associations between scenario attributes.

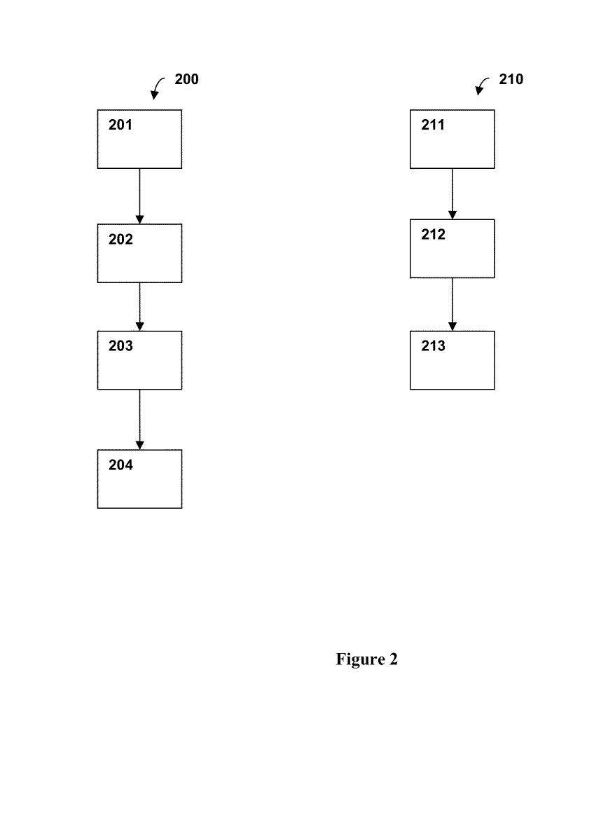

In an embodiment, it is possible that a user can provide less than all of the scenario attributes that apply to a particular job. As such, the job analysis engine 120 can add additional scenario attributes to the user-provided scenario attributes 102 to complete the necessary set of scenario attributes and generate the user-defined scenario 107 based on the user-defined scenario attributes 102 and the additional scenario attributes. As illustrated by the execution of the job analysis workflow 200 in FIG. 2, the request 101 is received at step 201. At step 202, job analysis engine 120 can determine whether additional scenario attributes are necessary according to the quantified market value dimensionalities 105. In an embodiment, the determination can be performed by a comparison with the scenario attributes 104 of the defined scenario 103 to see if a discrepancy in attributes exists between the request 101 and the defined scenario 103. In this embodiment, the quantified market value dimensionalities 105 can be used to complement or override the inclusion of additional attributes based on the comparison. If additional scenario attributes are necessary, the scenario attributes are added at step 203. The additional scenario attributes can include scenario attributes 104 from the defined scenario 103 (i.e., some or all of those lacking in the request 101), and/or can be determined by rules of the quantified market value dimensionalities 105 and retrieved from the global attribute database. The additional scenario attributes can include corresponding additional scenario attribute values. For example, for a particular job, the user may include a jurisdictional scenario attribute (including a value indicating the desired jurisdiction for the job), but not include an education and/or licensing attribute in the request even though the job requires a certain education level and/or professional license in that particular jurisdiction. In this example, the rules of the quantified market value dimensionalities 105 for that job and jurisdiction include that the education and/or licensing attributes are required to accurately model the job, and as such the education and/or licensing attributes are retrieved. In addition, the request 101 can include user-defined scenario attributes 102 that may be unnecessary for the job (e.g., they are not factors in the market value for a job, rendered irrelevant due to the existence of other attributes, etc.). The unnecessary attributes can be identified at step 202 according to the quantified market value dimensionalities 105 and/or the scenario attributes 104 of the defined scenario 103 and removed from the generation process by the job modeling engine 120 at step 203. At step 204, the job analysis engine generates the user-defined scenario 107 based on the scenario attributes (user-defined attributes and values, and any additional attributes and, if applicable, values) included after any additions or removals, according to the associations of the attributes and the quantified market value dimensionalities.

In an embodiment, the job modeling engine 120 can execute job analysis workflow 210 as shown in FIG. 2 and change the scenario attribute values for one or more scenario attributes to bring the values in line with the market value. The scenario attribute values being modified can be for the user-defined scenario attributes 102. In embodiments where additional scenario attributes can be added by the job analysis engine 120, the modified values can correspond to one or more of the user-defined scenario attributes 102, the additional scenario attributes, or both. The modifications can be made by selecting a subset of one or more of the user-defined scenario attributes as primary attributes at step 211, which are used as the basis of the modification. The primary attributes can reflect the user-defined attributes 102 that are most important or critical to the user requesting the job scenario. The primary attribute values corresponding to the selected primary attributes can be considered to be constants, which are not modified. The remaining attribute values (i.e., the attribute values of user-defined attributes that were not identified as primary attributes) can be modified based on the primary attribute values and the quantified market value dimensionalities 105 at step 212. The modification can be a corresponding adjustment of the remaining attribute values by considering the primary attribute values as reflecting proper market values of those attributes. The remaining attribute values are then modified or generated according to the values, weights and rules of the quantified market value dimensionalities 105 and consistent with the primary attributes and their values. For example, if the salary and experience attributes provided by the user are selected as primary attributes, the remaining attribute values would be adjusted to levels commiserate with the market value of the job at that salary and experience level. In another example, the modification to the remaining attribute values can be made to compensate for the primary attribute values (e.g., if the primary attribute values are near the bounds of set thresholds or ranges for those values), so that the user-defined scenario 107 maintains the primary attribute values but is also collectively within market value. The user-defined scenario 107 is then generated at step 213.

The primary attributes can be user-identified, or identified according to the quantified market value dimensionalities 105 (such as by those attributes carrying the most weight, or deemed to be most closely tied to the market value for a job). The primary attributes can be attributes representing requirements for the job according the organization, a jurisdiction, a legal requirement, etc.

In an embodiment, the modifications to one or more of the attribute values can be calculated, but the user-defined scenario 107 generated based on the pre-modification attribute values. The differences can be presented along with the user-defined scenario 107 to illustrate the deviation. The quantified market value dimensionalities used in the calculations can be explained to the user, so that the user can understand why the deviations exist.

It is possible that, given the user-defined scenario attributes 102 (including user-defined scenario attribute values), a user-defined scenario 107 cannot be constructed. This can be because, for example, the scenario attribute values provided by the user exceed predefined thresholds regarding realistic or possible job scenarios. The thresholds can be based on quantified market value dimensionalities for a job that eliminate the generation of job scenarios that are unrealistic or logically impossible. For example, a scenario where a high-level job including a minimum-wage salary. In another example, the job scenario could be for a job that has not been previously observed to exist in a particular location. In still another example, the job requested could be one for a job requiring a certain level of education and licensing, yet the user-defined attributes for education and licensing include user-defined attribute values below the requirements. Other thresholds can be set to warn a user of a job scenario that is possible, but improbable. For example, this can include the generation of a particular kind of job that is typically not a part of an organization of the size or type of the requesting user. In an embodiment, where a user-defined scenario 107 cannot be constructed, the job modeling engine 120 can modify the attributes and/or attribute values (such as by using one or more of the job analysis workflows 200, 210), so that one or more ‘possible’ scenarios can be generated. These alternative scenarios can be presented to the user, including an identification of what attributes and/or attribute values provided by the user made the user-defined scenario 107 impossible to generate.

In an embodiment, the job modeling engine 120 can be used to determine a job for a set of attributes according to market values for various jobs. In this embodiment, the user can create a request having attributes with defined attribute values. The job modeling engine 120 can then determine, for the provided user-defined attributes and values, possible jobs that fit the description, such as by matching the attributes and values to attributes and values of defined jobs that match or approximately match. The matching can be performed according to the matching techniques listed above. For example, a user can provide attributes describing multiple tasks at a particular job that an existing employee performs, and other information such as salary, location, etc. From these attributes, the system can return defined jobs that best fit the tasks that the employee performs, and can present analysis for market value for one or more of these returned jobs as described above, so that the organization can determine what job it is the employee actually fills and how the employee's fill of the job benchmarks against market value for the job.

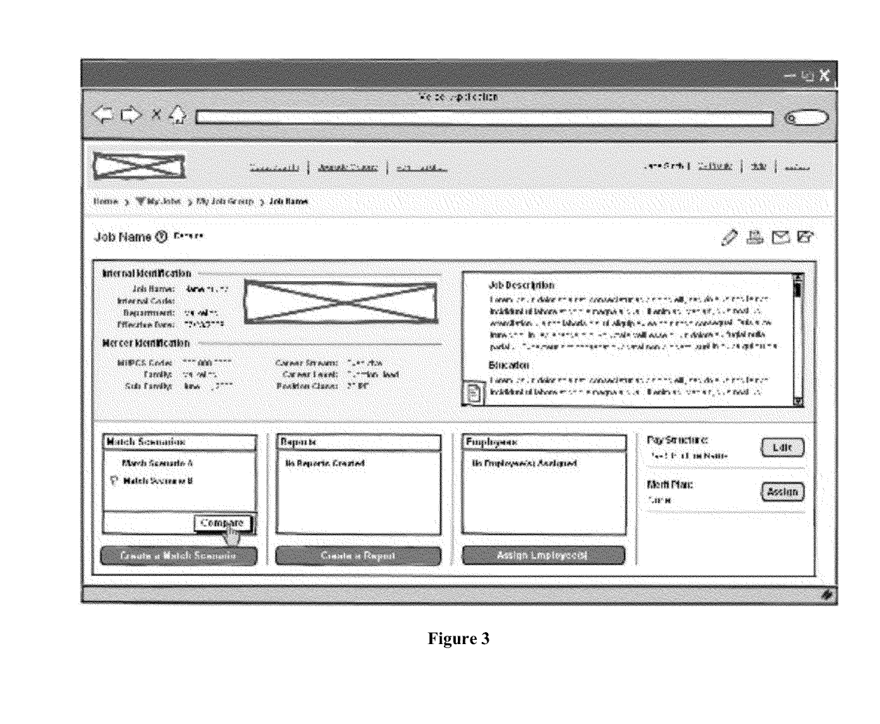

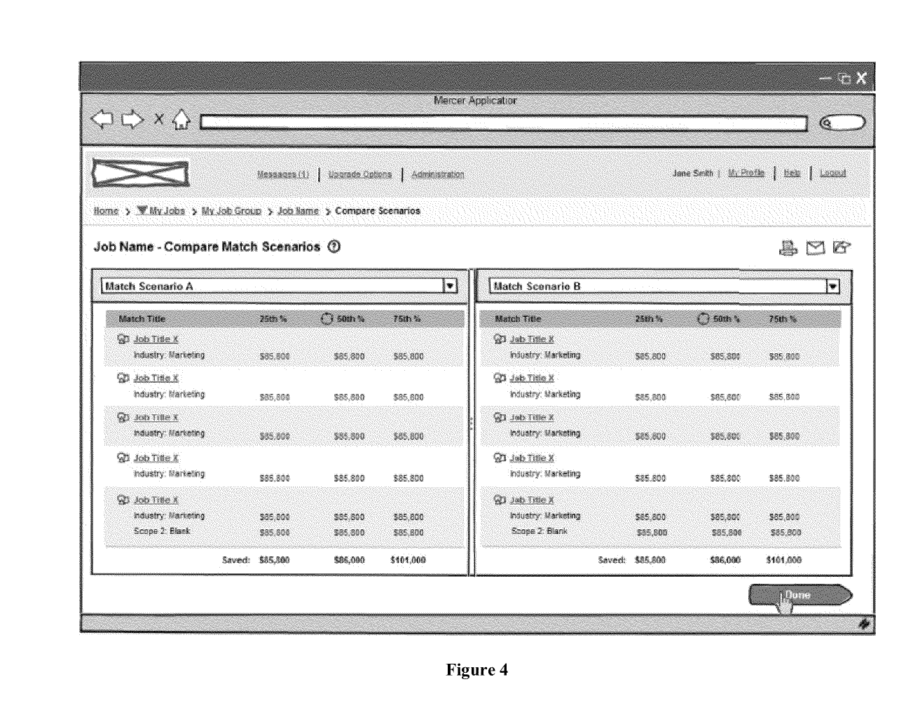

Further, the contemplated method can configure an output device, via the job modeling engine 120, to present the job based on user-defined scenarios. FIG. 3 provides an example of the user interface where a user can select to view one or more generated scenarios for a job. In comparing the scenarios, the system can display percentiles, match titles, and/or industries as shown in one embodiment in FIG. 4. The modeling engine 120 can create one or more reports that preset a visualization of the benchmark scenarios. In some embodiments, the scenarios can be presented in graphical form, possibly as a line graph, scatter chart, 3D graph, or other type of chart. Such an approach is considered advantageous when a number of scenarios are sufficient for statistical analysis. The output device can include computing devices having a monitor, sound output devices, and other output peripherals that allow the user to receive the output generated by the system.

Following the configuration of the output device, the user can activate a job by activating one or more of the presented user-defined scenarios 107 as a description for the job. For example, upon selection of a desired scenario, possibly in response to a recommendation from the modeling engine, the scenarios can be formatted and sent to an HR system 130. The scenario could be packaged as an XML file including tags having defined values (e.g., name, title, salary, experience requirements, jurisdiction, etc.). The HR computer system or database 130 can then accept the file can create an active job based on the scenario defined values.

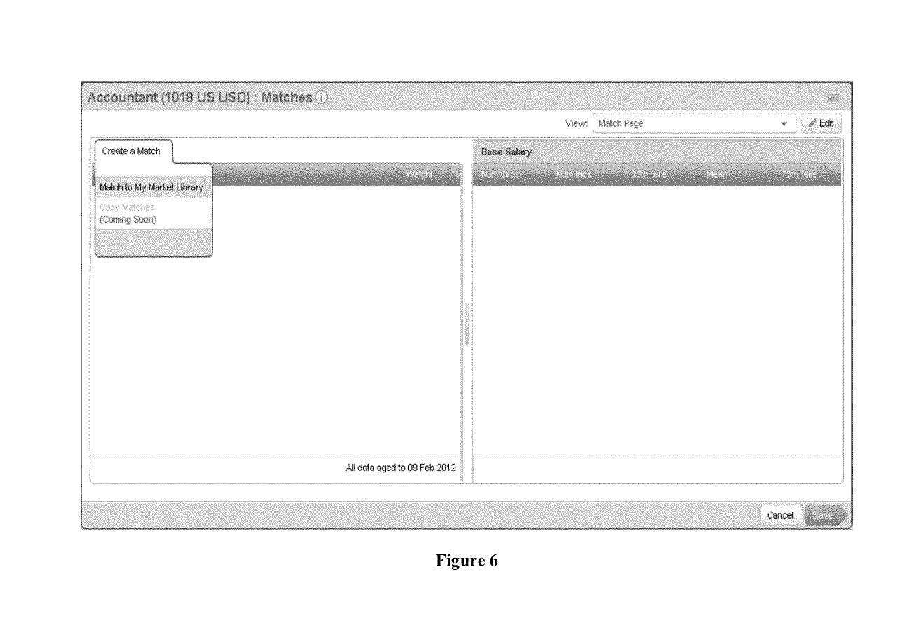

Another aspect of the inventive subject matter includes the flexibility in displaying the job on the output device. For example, the output device can be configured to rank the user-defined scenarios according to at least one dimensionality of the market value. Additionally, user-defined scenarios can be presented according to a job metric derived from existing jobs stored in a job benchmark database, such as salary range and/or percentile, as illustrated in the example user interface screens shown in FIG. 4 and FIG. 6. Additionally, the output device can be configured to present a comparison of at least one user-defined scenario with respect to at least one existing job from the job benchmark database.

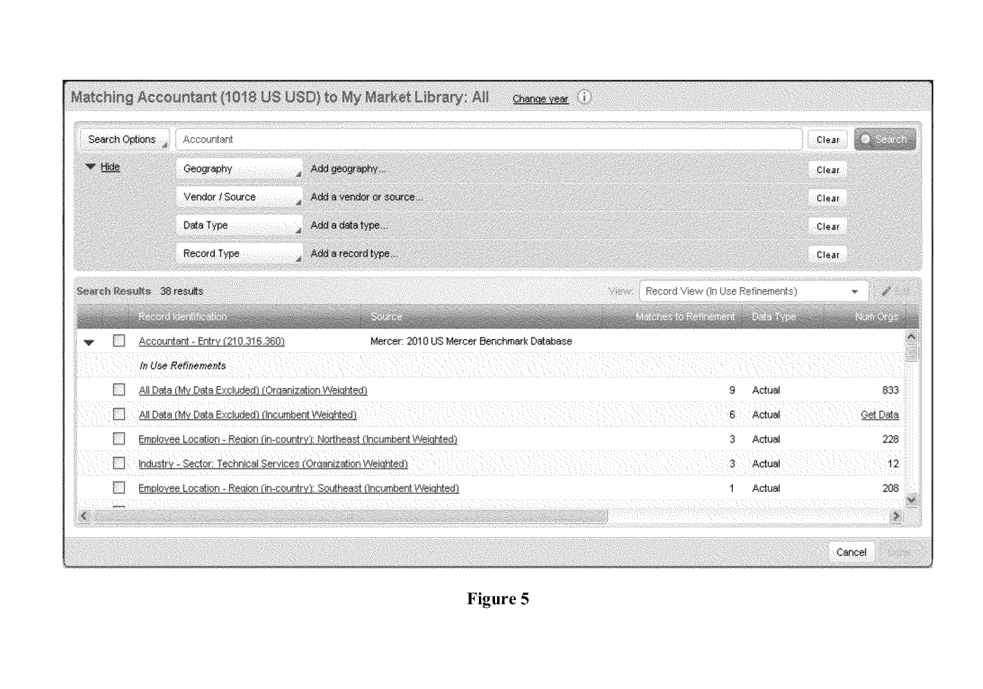

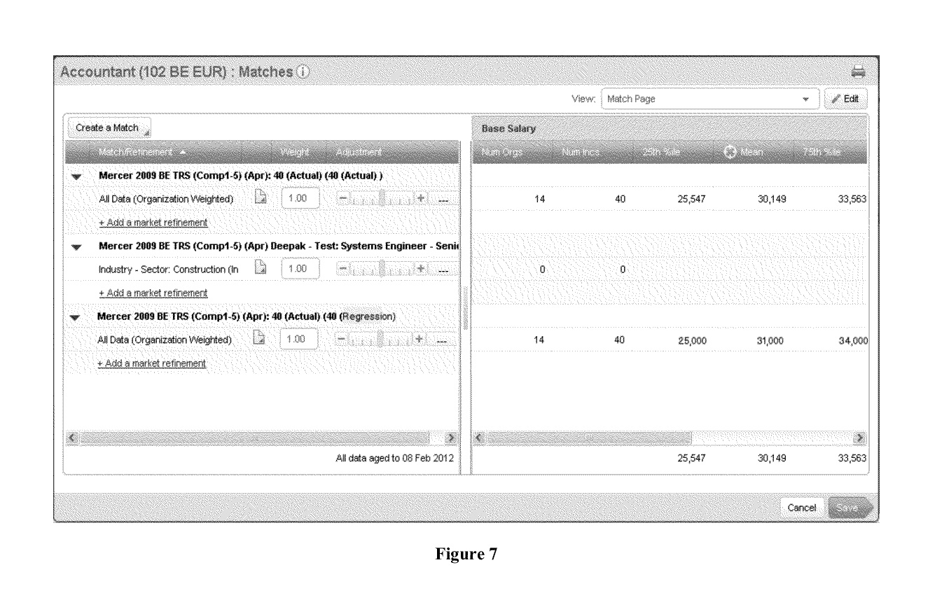

Alternatively, contemplated methods can query a job benchmark database to obtain an existing job from which the metric is derived. Querying the job benchmark database can include constructing a query based on job attributes, including the scenario attributes available in making the request, such as an organization, an organization classification, a location, an industry, an industry sector, a monetary value, a position classification, a job name. The query can also be based on other job attributes beyond the scenario attributes used in the generation process. For example, the query can be based on one or more actual employees currently filling the roles. FIG. 5 provides an example of the user interface screen that enables the user to generate a query. After such factors are applied, the output device can produce a populated list and apply it to the user interface screen depicted in FIG. 6, as illustrated in one embodiment in FIG. 7.

It is important to note that the user interface examples in FIGS. 3-7 provided are to illustrate the user-facing output aspects of the inventive subject matter. As the screens are used as illustrative examples, the data content within the examples was data used for illustrative purposes and/or system testing. As such, the methods and systems of the inventive subject matter are not to be interpreted as being limited to executions that result in only the data presented in these figures. For example, FIG. 2 contains entries for each of “Match Scenario A” and “Match Scenario B” that contain similar or identical entries. These entries were used for testing and illustrative purposes only

A user can activate one or more of the scenarios as the candidate description. Activating can include converting at least one of the user-define scenarios into a standardized candidate description compatible with a human resource engine 130, possibly based on XML or other format. In such a case, the candidate description is made official by placing it in a human resources system 130. However, it is contemplated that the job modeling engine 120 can submit the standardized candidate description to the human resource engine over a network data connection. In activating the user-defined scenario 107, the selection of a candidate scenario among multiple user-defined scenarios 107 for the same job can be based on a best fit of the scenarios according to the priorities of the organization (i.e., which scenario fits the most important attributes for the company the best), by hierarchy of organization members requesting the scenarios, etc. The formatting of the description can include a formatting of the scenario 107, to include information for compliance with organization, jurisdictional, legal and other requirements (such as by including information regarding legal obligations, compliance with employment laws, advertisement laws, anti-discrimination laws, etc.), as necessary for use by HR system 130.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for benchmarking a job, comprising:
receiving, by a job modeling engine, a request for a user-defined scenario for a job, the request including a plurality of user-defined scenario attributes associated with the job, each of the plurality of user-defined scenario attributes having a corresponding user-defined scenario attribute value;
generating, by the job modeling engine, the user-defined scenario as a function of the plurality of user-defined scenario attribute values and at least one defined scenario representative of a market value of the job; and
configuring an output device, by the job modeling engine, to present the job according to the user-defined scenario.

2. The method of claim 1, wherein the step of generating the user-defined scenario comprises executing a job analysis workflow for the plurality of user defined scenario attributes with respect to the market value of the job.

3. The method of claim 2, wherein the market value comprises a plurality of quantified market value dimensionalities.

4. The method of claim 3, wherein the step of executing a job analysis workflow comprises:
selecting, by the job modeling engine, at least one additional scenario attribute associated with the job based on the at least one of the plurality of user-defined scenario attributes and the plurality of quantified market value dimensionalities; and
generating, by the job modeling engine, an additional scenario attribute value for each of the at least one additional scenario attribute based on at least one of the plurality of user-defined scenario attribute values and the plurality of quantified market value dimensionalities.

5. The method of claim 3, wherein the step of executing a job analysis workflow comprises:
identifying a subset of the plurality of user-defined attributes as primary attributes based on the quantified market value dimensionalities, wherein the subset comprises at least one of but less than all of the plurality of user-defined attributes; and
modifying the attribute value for at least one of the user-defined attributes that is not a primary attribute based on the primary attribute values and the quantified market value dimensionalities.

6. The method of claim 3, wherein the plurality of quantified dimensionalities include at least two of the following: a non-monetary impact of the job on an organization, a need of the job for an organization, an institutional culture of an organization, a geography, an impact of the job on a local economy or good-will, effect of jurisdictional requirements on job (e.g., laws, codes, regulations, standards, licensing requirements etc.), a stress level associated with a job, a location, a monetary value normalization (e.g., location-based, institution-based, industry-based, etc.), a compensation package, a career projection, a position class, a demographic, a social status associated with job, a vendor, a reputation of a profession, educational requirements of the job, and a quality of life.

7. The method of claim 1, wherein the market value for the job represents a market segment value.

8. The method of claim 1, wherein the market value for the job represents a jurisdictional market value.

9. The method of claim 1, wherein the market value for the job represents a demographic value.

10. The method of claim 1, wherein the market value for the job represents a cultural value.

11. The method of claim 1, further comprising the step of activating, via the job modeling engine, at least one of the user-defined scenarios as a candidate description for the job.

12. The method of claim 11, wherein the step of activating one of the scenarios as the candidate description includes converting at least one of the user-defined scenarios into a standardized candidate description compatible with a human resource engine.

13. The method of claim 12, further comprising the job modeling engine submitting the standardized candidate description to the human resource engine.

14. The method of claim 1, where in the step of configuring the output device to present the job includes ranking the plurality of user-defined scenarios according to at least one dimensionality of the market value.

15. The method of claim 1, where in the step of configuring the output device to present the job includes presenting the plurality of user-defined scenarios according to a job metric derived from existing jobs stored in a job benchmark database.

16. The method of claim 15, where in the step of configuring the output device to present the job includes presenting a comparison of at least one of the plurality of user-defined scenarios with respect to at least one existing job from the job benchmark database.

17. The method of claim 15, further comprising querying a job benchmark database to obtain at least one existing job from which the metric is derived.

18. The method of claim 15, wherein the step of querying the job benchmark database includes constructing a query as a function of at least one of the following job attributes: an organization, an organization classification, a location, an industry sector, an employee, a monetary value, a position classification, a name, and a weighting.
